(19) United States
(12) Patent Application Publication
(10) Pub. No.: US 2012/0089755 A1
(43) Pub. Date: Apr. 12, 2012

(54) Method of adjusting transfer speed after initialization of SATA interface

(76) Inventors: Huei-Chiang Shiu, New Taipei City (TW); Teng-Chuan Hsieh, New Taipei City (TW); Hsieh-Huan Yen, Taipei City (TW)

(21) Appl. No.: 13/253,979

(22) Filed: Oct. 6, 2011

(30) Foreign Application Priority Data
Oct. 6, 2010 (TW) 099134012

(51) Int. Cl. G06F 3/00

(52) U.S. Cl. 710/60

(57) ABSTRACT

In a method of adjusting transfer speed after initialization of a SATA interface, a SATA link device transmits a first predetermined primitive to a SATA link partner for requesting to change a first transfer speed of the SATA link device from a first speed to a second speed, the SATA link partner replies to the SATA link device with a second predetermined primitive according to the first predetermined primitive, and the SATA link device and the SATA link partner respectively adjust the first transfer speed of the SATA link device and a second transfer speed of the SATA link partner according to the second predetermined primitive.

### BACKGROUND OF THE INVENTION

1. Field of the Invention

The present invention relates to methods of adjusting transfer speed, and particularly to a method of adjusting transfer speed after Serial Advanced Technology Attachment (SATA) interface initialization and related device.

2. Description of the Prior Art

Please refer to FIG. 1, which is a diagram illustrating a SATA link device LD and a SATA link partner LP setting transfer speed during initialization of a SATA interface. In FIG. 1, the SATA link device LD is a host, and the SATA link partner LP is a device. COMRESET, COMINIT, and COMWEAK are out of band (OOB) signals defined for the SATA interface. SATA interface transfer speed is normally 150 MHz, 75 MHz, or 37.5 MHz. However, SATA devices send OOB signals at the transfer speed lower than 37.5 MHz. ALIGN is an aligning primitive command defined for the SATA interface. During SATA interface initialization, the SATA link device LD first sends OOB signal COMRESET for indicating a need to reset the SATA interface, and the SATA link partner LP responds with OOB signal COMINIT to confirm resetting of the SATA interface. The SATA link device LD and the SATA link partner LP send OOB signals COMWEAK to each other. Then, the SATA link device LD and the SATA link partner LP begin performing an alignment process. For example, in the alignment process, the SATA link device LD sends a plurality of aligning primitive commands ALIGN at the maximum transfer speed supported by the SATA link device LD, and the SATA link partner LP sends a plurality of aligning primitive commands ALIGN at the maximum transfer speed supported by the SATA partner device LP. If at this time, the SATA link device LD and the SATA link partner LP operate at the same transfer speed, e.g. 150 MHz, the SATA link device LD may receive M aligning primitive s ALIGN, and the SATA link partner LP may receive N aligning primitives ALIGN, where M and N are integers. When M and N are both greater than or equal to a threshold number NUMTH, meaning that the SATA link device LD and the SATA link partner LP both successfully receive at least NUMTH aligning primitive commands ALIGN, the aligning process is completed. The SATA link device LD and the SATA link partner LP then enter IDLE mode, and the SATA link device LD and the SATA link partner LP may send data to each other at the transfer speed of the aligning process, e.g. 150 MHz.

If the SATA link device LD supports transfer speeds of 150 MHz, 75 MHz, and 37.5 MHz, and the SATA link partner LP supports transfer speeds of 75 MHz and 37.5 MHz, during the aligning process, the SATA link device LD will use its highest transfer speed (150 MHz) to send the aligning primitives ALIGN, and the SATA link partner LP will use its highest transfer speed (75 MHz) to send the aligning primitives ALIGN. Because the SATA link device LD and the SATA link partner LP operate at different transfer speeds, the SATA link device LD and the SATA link partner LP are unable to receive the aligning primitives ALIGN sent from each other. Thus, the SATA link device LD and the SATA link partner LP are unable to complete the aligning process. So, the SATA link device LD and the SATA link partner LP will both lower their transfer speed, and perform the aligning process again. The SATA link device LD lowers its transfer speed to 75 MHz, and the SATA link partner LP lowers its transfer speed to 37.5 MHz. Because the SATA link device LD and the SATA link partner LP are still operating at different transfer speeds, the SATA link device LD and the SATA link partner LP are unable to complete the aligning process. Thus, the SATA link device LD will lower its transfer speed to 37.5 MHz. The SATA link partner LP is already operating at its lowest transfer speed, so the SATA link partner LP keeps its transfer speed at 37.5 MHz. In this way, the SATA link device LD and the SATA link partner LP operate at the same transfer speed (37.5 MHz), so the SATA link device LD and the SATA link partner LP are able to complete the aligning process, and enter into standby mode.

It can be seen from the above description that, although the SATA link device LD and the SATA link partner LP are both able to operate at the transfer speed of 75 MHz, the method of setting transfer speed in the initialization of the SATA interface leads to the SATA link device LD and the SATA link partner LP only being able to transfer data at the minimum transfer speed (37.5 MHz). As long as the maximum transfer speeds supported by the SATA link device LD and the SATA link partner LP are different, the SATA link device LD and the SATA link partner LP will end up using the lowest transfer speed (37.5 MHz) to transmit data. The SATA link device LD and the SATA link partner LP cannot utilize the most efficient transfer speed to transmit data. Further, after initialization of the SATA interface, the SATA link device LD and the SATA link partner LP can only use a fixed transfer speed for transmitting data. Thus, after initialization, the user is unable to lower the transfer speed of the SATA interface to save power, and is also unable to increase the transfer speed of the SATA interface to save time, which is a great inconvenience to the user.

### SUMMARY OF THE INVENTION

In an embodiment, a method of adjusting transfer speed after initialization of a Serial Advanced Technology Attachment (SATA) interface comprises a SATA link device sending a first predetermined primitive to a SATA link partner for inquiring whether a first transfer speed of the SATA link device can be adjusted from a first predetermined transfer speed to a second predetermined transfer speed; the SATA link partner responding to the SATA link device with a second predetermined primitive according to the first predetermined primitive; the SATA link device adjusting the first transfer speed of the SATA link device according to the second predetermined primitive; and the SATA link partner adjusting a second transfer speed of the SATA link partner according to the second predetermined primitive.

In an embodiment, a device for adjusting transfer speed after initialization of a Serial Advanced Technology Attachment (SATA) interface comprises a SATA link device and a SATA link partner. The SATA link device comprises a first physical layer device for sending and receiving data at a first transfer speed, and a first data link layer device for sending a first predetermined primitive through the first physical layer to inquire whether the first transfer speed of the first physical layer device can be adjusted from a first predetermined transfer speed to a second predetermined transfer speed. The SATA link partner comprises a second physical layer device for sending and receiving data at a second transfer speed, and a second data link layer device for sending a second predetermined primitive through the second physical layer. The second data link layer device of the SATA link partner responds to the SATA link device with the second predetermined primitive when the first data link layer device of the SATA link device sends the first predetermined primitive to the second data link layer device of the SATA link partner. The first physical layer device of the SATA link device adjusts the first transfer speed to the second predetermined transfer speed, and the second physical layer device of the SATA link partner adjusts the second transfer speed to the second predetermined transfer speed when the second predetermined primitive indicates acceptance. The first physical layer device of the SATA link device maintains the first transfer speed at the first predetermined transfer speed, and the second physical layer device of the SATA link partner maintains the second transfer speed at the first predetermined transfer speed when the second predetermined primitive indicates rejection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a SATA link device and a SATA link partner setting transfer speed during initialization of a SATA interface.

FIG. 2 and FIG. 3 are diagrams illustrating a process for modifying transfer speed after initialization of a SATA interface.

FIG. 4 and FIG. 5 are diagrams illustrating detailed operating principles of the aligning process.

FIG. 6 is a diagram illustrating a device that adjusts transfer speed after initialization of a SATA interface.

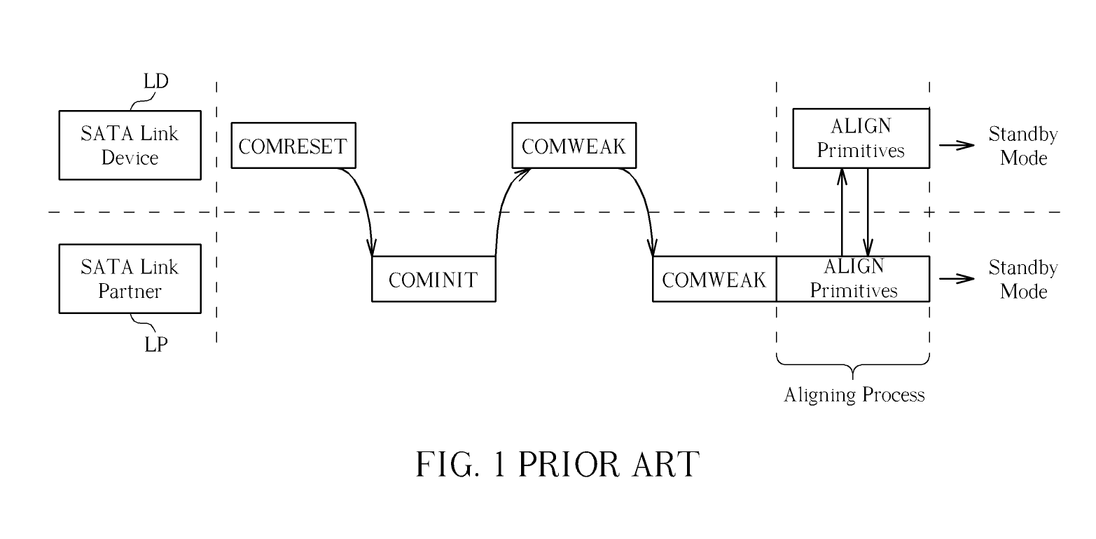

### DETAILED DESCRIPTION

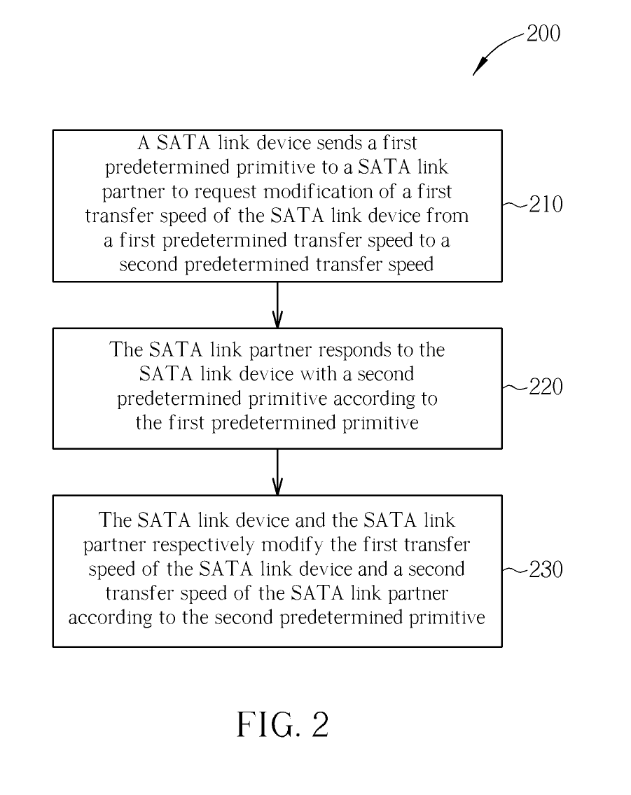

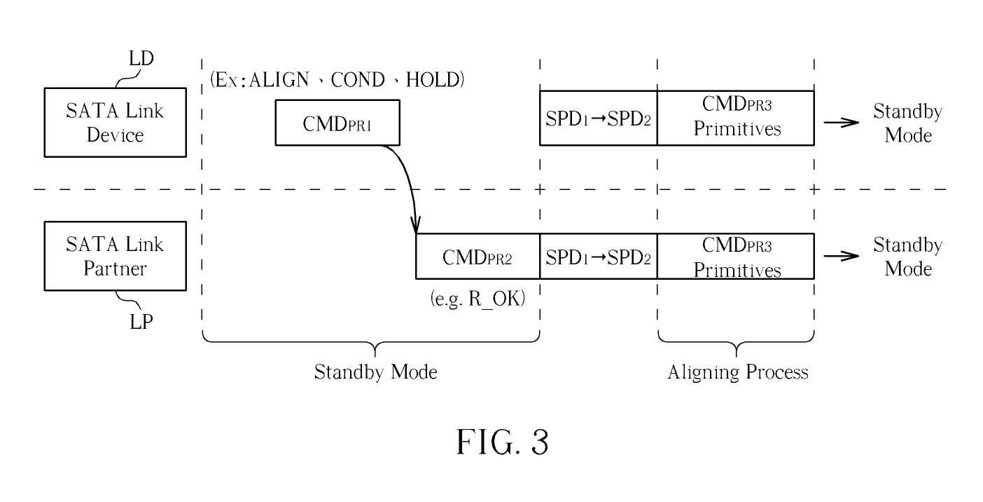

Please refer to FIG. 2 and FIG. 3. FIG. 2 and FIG. 3 are diagrams illustrating a process 200 for modifying transfer speed after initialization of a SATA interface. In FIG. 2 and FIG. 3, it is assumed that a SATA link device LD and a SATA link partner LP have already performed alignment during initialization. Transfer speed SPD_{LD} of the SATA link device LD and transfer speed SPD_{LP} of the SATA link partner LP are both transfer speed SPD₁ (SPD₁ may be 150 MHz, 75 MHz, or 37.5 MHz), and the SATA link device LD and the SATA link partner LP are both in standby mode. The process 200 comprises the following steps:

Step 210: The SATA link device LD sends a predetermined primitive CMD_{PR1} to the SATA link partner LP to request modification of the transfer speed SPD_{LD} of the SATA link device LD from transfer speed SPD₁ to transfer speed SPD₂;

Step 220: The SATA link partner LP responds to the SATA link device LD with a predetermined primitive CMD_{PR2} according to the predetermined primitive CMD_{PR1}; and

Step 230: The SATA link device LD and the SATA link partner LP respectively modify the transfer speed SPD_{LD} of the SATA link device LD and the transfer speed SPD_{LP} of the SATA link partner LP according to the predetermined primitive CMD_{PR2}.

According to the SATA interface specification, when the SATA link device LD and the SATA link partner LP are in standby mode, the SATA link device LD and the SATA link partner LP do not use the aligning primitives (ALIGN), continue primitives (CONT), or hold primitives (HOLD) of the SATA interface. Thus, in step 210 of the process 200, the aligning primitives, the continue primitives, and the hold primitives may be utilized as the predetermined primitive CMD_{PR1} for the SATA link device LD to request modification of the transfer speed SPD_{LD} of the SATA link device LD from transfer speed SPD₁ to transfer speed SPD₂ during standby mode. For example, when the SATA link device LD sends aligning primitives, this may represent the SATA link device LD requesting modification of the transfer speed of the SATA link device LD from the transfer speed SPD₁ to 150 MHz (transfer speed SPD₂ equals 150 MHz). When the SATA link device LD sends continue primitives, this may represent the SATA link device LD requesting modification of the transfer speed SPD_{LD} of the SATA link device LD from the transfer speed SPD₁ to 75 MHz (transfer speed SPD₂ equals 75 MHz). When the SATA link device LD sends hold primitives, this may represent the SATA link device LD requesting modification of the transfer speed SPD_{LD} of the SATA link device LD from transfer speed SPD₁ to 37.5 MHz (transfer speed SPD₂ equals 37.5 MHz).

In step 220, the SATA link partner LP responds to the SATA link device LD with a predetermined primitive CMD_{PR2} according to the predetermined primitive CMD_{PR1}. When the predetermined primitive CMD_{PR2} represents “accepted” (for example, the predetermined primitive CMD_{PR2} may be a reception primitive R_OK of the SATA interface), this means the SATA link partner LP accepts modification of the transfer speed from SPD₁ to SPD₂. When the predetermined primitive CMD_{PR2} represents “rejected” (for example, the predetermined primitive CMD_{PR2} may be a reception primitive R_ERROR of the SATA interface), this means the SATA link partner LP rejects modification of the transfer speed from SPD₁ to SPD₂.

In Step 230, the SATA link device LD and the SATA link partner LP respectively modify the transfer speed SPD_{LD} of the SATA link device LD and the transfer speed SPD_{LP} of the SATA link partner LP according to the predetermined primitive CMD_{PR2}. When the predetermined primitive CMD_{PR2} represents “rejected”, the SATA link device LD maintains the transfer speed SPD_{LD} of the SATA link device LD at the transfer speed SPD₁, and the SATA link partner LP maintains the transfer speed SPD_{LP} of the SATA link partner LP at the transfer speed SPD₁. When the predetermined primitive CMD_{PR2} represents “accepted”, the SATA link device LD modifies its transfer speed SPD_{LD} to the transfer speed SPD₂, and the SATA link partner LP modifies its transfer speed SPD_{LD} to the transfer speed SPD₂.

Please refer to FIG. 3, which is a diagram illustrating the SATA link device LD and the SATA link partner LP modifying transfer speed when the predetermined primitive CMD_{PR2} represents “accepted”. To modify the transfer speed to SPD₂, the SATA link device LD and the SATA link partner LP transmit a plurality of predetermined primitives CMD_{PR3} to each other using the transfer speed SPD₂ for the SATA link device LD and the SATA link partner LP to complete an aligning process. The predetermined primitives CMD_{PR3} may be aligning primitives (ALIGN) of the SATA interface. At this time, the SATA link device LD receives M predetermined primitives CMD_{PR3} (e.g. aligning primitives ALIGN), and the SATA link partner LP receives N predetermined primitives CMD_{PR3}, where M and N are integers. When M and N are both greater than or equal to a threshold number NUM_{TH}, meaning the SATA link device LD and the SATA link partner LP have both successfully received at least the threshold number NUM_{TH} of predetermined primitives CMD_{PR3}, the aligning process is complete. The SATA link device LD and the SATA link partner LP enter standby mode, and the SATA link device LD and the SATA link partner LP may transmit data to each other at the transfer speed SPD₂.

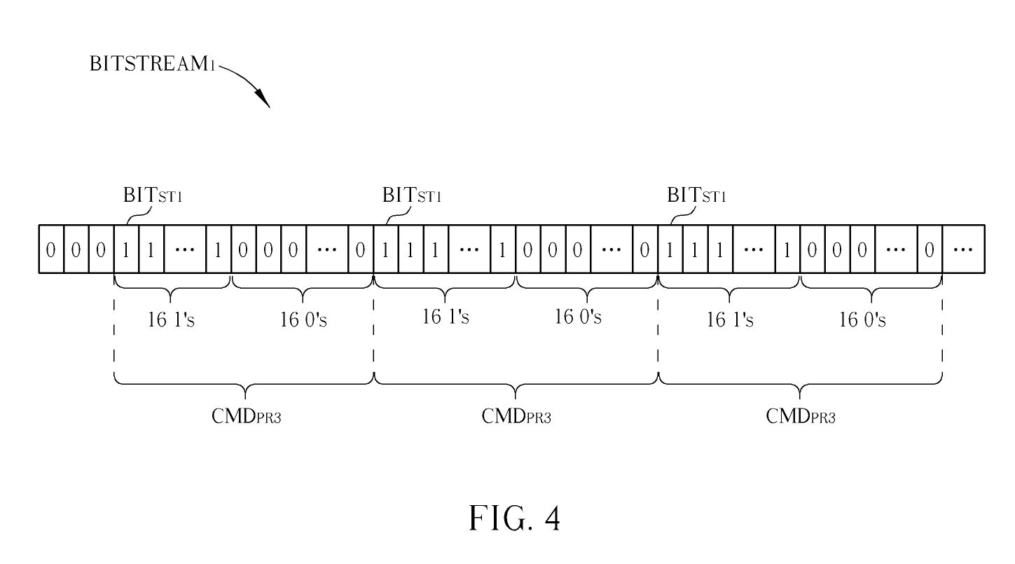

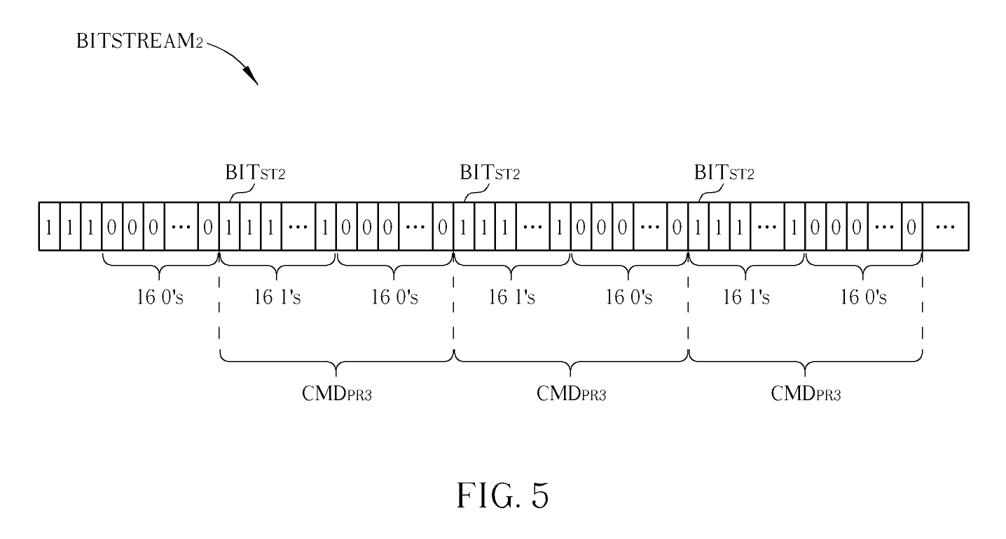

Please refer to FIG. 4 and FIG. 5. FIG. 4 and FIG. 5 are diagrams illustrating detailed operating principles of the aligning process. As shown in FIG. 4, in the aligning process, when the SATA link device LD receives the predetermined primitives CMD_{PR3} sent by the SATA link partner LP, the SATA link device LD actually receives a bitstream BITSTREAM₁. In other words, the SATA link device LD must identify the predetermined primitives CMD_{PR3} from the bitstream BITSTREAM₁. Content of the predetermined primitives CMD_{PR3} is known. For example, the predetermined primitives CMD_{PR3} may comprise 32 bits, and for simplicity of illustration, it is assumed that the content of the predetermined primitives CMD_{PR3} is formed of 16 consecutive logic “1” bits followed by 16 consecutive logic “0” bits. In this way, the SATA link device LD may identify predetermined primitives CMD_{PR3} in the bitstream BITSTREAM₁ according to the contents of the predetermined primitives CMD_{PR3}. When the SATA link device LD identifies at least the threshold number NUM_{TH} of predetermined primitives CMD_{PR3} from the bitstream BITSTREAM₁, the SATA link device LD obtains a first data read level according to the M predetermined primitives CMD_{PR3} identified. The first data read level is utilized for indicating a beginning bit BIT_{ST1} when the SATA link partner LP sends data. For example, in FIG. 4, the first bit of each predetermined primitive CMD_{PR3} is the beginning bit BIT_{ST1}. Thus, after the aligning process, when the SATA link device LD receives data transmitted from the SATA link partner LP, the SATA link device LD can segment the bitstream sent by the SATA link partner LP into 32-bit groups of data according to location of the beginning bit BIT_{ST1}. In this way, the SATA link device LD may read the data sent from the SATA link partner LP according to the beginning bit BIT_{ST1}. As shown in FIG. 5, in the aligning process, when the SATA link partner LP receives the predetermined primitive CMD_{PR3} sent from the SATA link device LD, the SATA link partner LP actually receives a bitstream BITSTREAM₂. At this time, the SATA link partner LP may obtain a second data read level according to N identified predetermined primitives CMD_{PR3}. The second data read level is utilized for indicating a beginning bit BIT_{ST2} when the SATA link device LD sends data. Thus, after the aligning process, when the SATA link partner LP receives the data sent from the SATA link device LD, the SATA link partner LP reads the data sent from the SATA link device LD according to location of the beginning bit BIT_{ST2}.

According to the process 200 described above, after initialization of the SATA interface, the SATA link device LD may send the predetermined primitives CMD_{PR1} to ask the SATA link partner LP whether the transfer speed SPD_{LD} of the SATA link device LD may be modified from the transfer speed SPD₁ to the transfer speed SPD₂. The SATA link partner LP may respond to the SATA link device LD through the predetermined primitives CMD_{PR2}. When the predetermined primitives CMD_{PR2} indicate acceptance, the SATA link device LD and the SATA link partner LP respectively modify the transfer speed SPD_{LD} of the SATA link device LD and the transfer speed SPD_{LP} of the SATA link partner LP, and the SATA link device LD and the SATA link partner LP complete the aligning process by sending the predetermined primitives CMD_{PR3} to each other. In this way, even after initialization of the SATA interface, the user may lower the transfer speed of the SATA interface to save power, or increase the transfer speed of the SATA interface to reduce transmission time. Further, even if the highest transfer speeds supported by the SATA link device LD and the SATA link partner LP are different, according to the above embodiments, the transfer speeds of the SATA link device LD and the SATA link partner LP may be adjusted to the most efficient transfer speed. For example, the SATA link device LD may support transfer speeds of 150 MHz, 75 MHz and 37.5 MHz, and the SATA link partner LP may support transfer speeds of 75 MHz and 37.5 MHz. After initialization, the SATA link device LD may send the predetermined primitives CMD_{PR1} to ask the SATA link partner LP whether the transfer speed SPD_{LP} of the SATA link partner LP can be changed from the transfer speed SPD₁ (37.5 MHz) to the transfer speed SPD₂ (75 MHz). In this way, after the SATA link device LD and the SATA link partner LP complete the aligning process, the transfer speed of 75 MHz may be utilized for transmitting data.

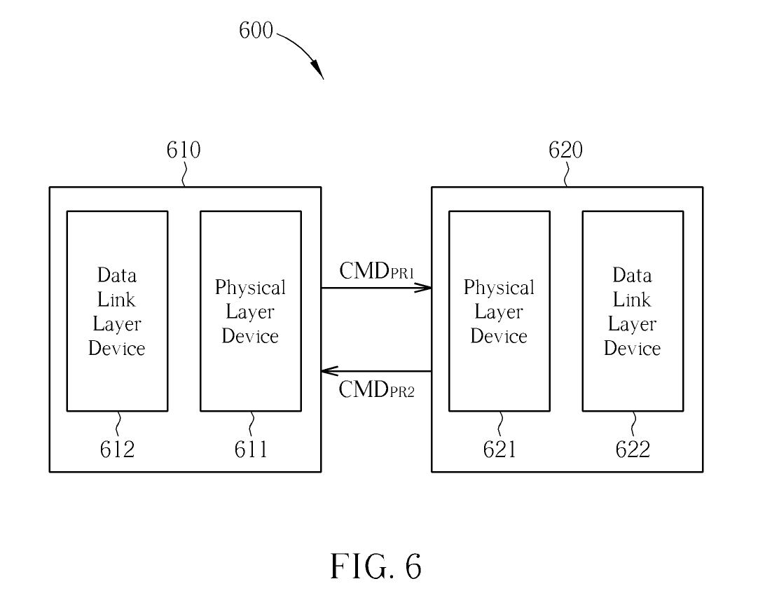

Please refer to FIG. 6. FIG. 6 is a diagram illustrating a device 600 that adjusts transfer speed after initialization of a SATA interface. The device 600 comprises a SATA link device 610 and a SATA link partner 620. The SATA link device 610 comprises a physical layer device 611, and a data link layer device 612. The physical layer device 611 is utilized for sending and receiving data at the transfer speed SPD_{LD}. The data link layer device 612 is utilized for sending the predetermined primitives CMD_{PR1} through the physical layer device 611 for asking whether the transfer speed SPD_{LD} of the physical layer device 611 can be adjusted from the transfer speed SPD₁ to the transfer speed SPD₂. The SATA link partner 620 comprises a physical layer 621 and a data link layer device 622. The physical layer 621 is utilized for sending and receiving data at the transfer speed SPD_{LP}. The data link layer device 622 is utilized for sending the predetermined primitives CMD_{PR2} through the physical layer 622.

More specifically, when the SATA link device 610 and the SATA link partner 620 are both in standby mode, the data link layer device 612 of the SATA link device 610 may send the predetermined primitives CMD_{PR1}. The predetermined primitives CMD_{PR1} may be aligning primitives, continue primitives, and hold primitives of the SATA interface. For example, when the data link layer device 612 sends the aligning primitives, this means the data link layer device 612 is asking whether the transfer speed SPD_{LD} of the physical layer device 611 can be adjusted from the transfer speed SPD₁ to 150 MHz (the transfer speed SPD₂ is 150 MHz). When the data link layer device 612 sends the continue primitives, this means the data link layer device 612 is asking whether the transfer speed SPD_{LD} of the physical layer device 611 can be adjusted from the transfer speed SPD₁ to 75 MHz (the transfer speed SPD₂ is 75 MHz). When the data link layer device 612 sends the hold primitives, this means the S data link layer device 612 is asking whether the transfer speed SPD_{LD} of the physical layer device 611 can be adjusted from the transfer speed SPD₁ to 37.5 MHz (the transfer speed SPD₂ is 37.5 MHz). When the data link layer device 612 of the SATA link device 610 sends the predetermined primitives CMD_{PR1} to the data link layer device 622 of the SATA link partner 620, the data link layer device 622 of the SATA link partner 620 utilizes the predetermined primitives CMD_{PR2} to respond to the SATA link device 610. For example, when the predetermined primitives CMD_{PR2} represent “accept”, the physical layer device 611 of the SATA link device 610 adjusts the transfer speed SPD_{LD} to the transfer speed SPD₂, and the physical layer device 621 of the SATA link partner 620 also adjusts the transfer speed SPD_{LP} to the transfer speed SPD₂. When the predetermined primitives CMD_{PR2} represent “reject”, the physical layer device 611 of the SATA link device 610 keep the transfer speed SPD_{LD} at the transfer speed SPD₁, and the physical layer device 621 of the SATA link partner 620 keeps the transfer speed SPD_{LP} at the transfer speed SPD₁.

More specifically, when the predetermined primitives CMDp_{R2} represent “accept”, the SATA link device 610 and the SATA link partner 620 perform an aligning process. In the aligning process, the data link layer device 612 of the SATA link device 610 and the data link layer device 622 of the SATA link partner 620 send a plurality of predetermined primitives CMD_{PR3} to each other at the transfer speed SPD₂ through the physical layer device 611 and the physical layer device 621, respectively. The predetermined primitives CMD_{PR3} may be SATA interface aligning primitives. At this time, the data link layer device 612 of the SATA link device 610 receives M predetermined primitives CMD_{PR3} sent by the SATA link partner 620, and the data link layer device 622 of the SATA link partner 620 receives N predetermined primitives CMD_{PR3} sent from the SATA link device 610, where M and N are integers. When M and N are both greater than or equal to a threshold number NUM_{TH}, it means the SATA link device 610 and the SATA link partner 620 have completed the aligning process. After the aligning process is complete, the SATA link device 610 and the SATA link partner 620 both enter standby mode.

In the aligning process, the data link layer device 612 of the SATA link device 610 obtains a first data read level according to M predetermined primitives CMD_{PR3} sent by the SATA link partner 620. The first data read level is utilized for indicating a beginning bit BIT_{ST1} when the SATA link partner 620 sends data. Operating principles thereof are described above in the description related to FIG. 4, and are not repeated here. In this way, after the aligning process, when the SATA link device 610 receives data sent by the SATA link partner 620, the data link layer device 612 of the SATA link device 610 may read the data sent by the SATA link partner 620 according to the beginning bit BIT_{ST1}. In the aligning process, the data link layer device 622 of the SATA link partner 620 obtains a second data read level according to N predetermined primitives CMD_{PR3} sent by the SATA link device 610. The second data read level is utilized for indicating a beginning bit BIT_{ST2} when the SATA link device 610 sends data. Operating principles thereof are described above in the description related to FIG. 5, and are not repeated here. In this way, after the aligning process, when the SATA link partner 620 receives data sent by the SATA link device 610, the data link layer device 622 of the SATA link partner 620 may read the data sent by the SATA link device 610 according to the beginning bit BIT_{ST2}.

A method of adjusting transfer speed after initialization of a SATA interface is provided. According to the method provided, the SATA link device may send a first predetermined primitive to inquire of the SATA link partner whether a first transfer speed of the SATA link device LD may be adjusted from the first transfer speed to a second transfer speed. The SATA link partner may send a second predetermined primitive to respond to the SATA link device. When the second predetermined primitive represents “accept”, the SATA link device and the SATA link partner each adjust their transfer speed to the second transfer speed, and the SATA link device and the SATA link partner send a plurality of third predetermined primitives to each other for completing an aligning process. In this way, even after initialization of the SATA interface, the user may still lower the transfer speed of the SATA interface to save power, or increase the transfer speed of the SATA interface to save transfer time. Further, even if the maximum transfer speeds supported by the SATA link device LD and the SATA link partner LP are different, by employing the method described above, the transfer speeds of the SATA link device LD and the SATA link partner LP can be adjusted to the most efficient transfer speed after initialization, increasing convenience to the user.

Those skilled in the art will readily observe that numerous modifications and alterations of the device and method may be made while retaining the teachings of the invention.

What is claimed is:

1. A method of adjusting transfer speed after initialization of a Serial Advanced Technology Attachment (SATA) interface, the method comprising:
a SATA link device sending a first predetermined primitive to a SATA link partner for inquiring whether a first transfer speed of the SATA link device can be adjusted from a first predetermined transfer speed to a second predetermined transfer speed;
the SATA link partner responding to the SATA link device with a second predetermined primitive according to the first predetermined primitive;
the SATA link device adjusting the first transfer speed of the SATA link device according to the second predetermined primitive; and
the SATA link partner adjusting a second transfer speed of the SATA link partner according to the second predetermined primitive.

2. The method of claim 1, wherein the steps of the SATA link device adjusting the first transfer speed of the SATA link device according to the second predetermined primitive, and the SATA link partner adjusting the second transfer speed of the SATA link partner according to the second predetermined primitive comprise:
the SATA link device adjusting the first transfer speed of the SATA link device to the second predetermined transfer speed, and the SATA link partner adjusting the second transfer speed of the SATA link partner to the second predetermined transfer speed when the second predetermined primitive indicates acceptance; and
the SATA link device maintaining the first transfer speed of the SATA link device at the first predetermined transfer speed, and the SATA link partner maintaining the second transfer speed of the SATA link partner at the first predetermined transfer speed when the second predetermined primitive indicates rejection.

3. The method of claim 2, wherein the step of the SATA link device adjusting the first transfer speed of the SATA link device to the second predetermined transfer speed, and the SATA link partner adjusting the second transfer speed of the SATA link partner to the second predetermined transfer speed when the second predetermined primitive indicates acceptance comprises:
the SATA link device and the SATA link partner sending a plurality of third predetermined primitives to each other at the second predetermined transfer speed for completing an alignment process between the SATA link device and the SATA link partner; and
the SATA link device and the SATA link partner entering a standby mode after completing the aligning process.

4. The method of claim 3, wherein the plurality of third predetermined primitives are aligning primitives of the SATA interface.

5. The method of claim 3, wherein the step of the SATA link device and the SATA link partner sending the plurality of third predetermined primitives to each other at the second predetermined transfer speed for completing the alignment process between the SATA link device and the SATA link partner comprises:
the SATA link device receiving M third predetermined primitives sent by the SATA link partner in the aligning process;
the SATA link partner receiving N third predetermined primitives sent by the SATA link device in the aligning process; and
the aligning process completing when M and N are both greater than or equal to a threshold number;
wherein M and N are integers.

6. The method of claim 5, wherein the step of the SATA link device receiving the M third predetermined primitives sent by the SATA link partner in the aligning process comprises:
the SATA link device obtaining a first data read level according to the M third predetermined primitives sent by the SATA link partner;
wherein the first data read level is utilized for indicating a first beginning bit when the SATA link partner transmits data; and
wherein the SATA link device reads the data sent by the SATA link partner according to the first beginning bit when the SATA link device receives the data sent by the SATA link partner after the aligning process.

7. The method of claim 5, wherein the step of the SATA link partner receiving the N third predetermined primitives sent by the SATA link device in the aligning process comprises:
the SATA link partner obtaining a second data read level according to the N third predetermined primitives sent by the SATA link device;
wherein the second data read level is utilized for indicating a second beginning bit when the SATA link device transmits data; and
wherein the SATA link partner reads the data sent by the SATA link device according to the second beginning bit when the SATA link partner receives the data sent by the SATA link device after the aligning process.

8. The method of claim 1, wherein the SATA link device and the SATA link partner are both in a standby mode when the SATA link device sends the first predetermined primitive.

9. The method of claim 1, wherein the first predetermined primitive is an aligning primitive (ALIGN), a continue primitive (CONT), or a hold primitive (HOLD) of the SATA interface.

10. The method of claim 1, wherein the first predetermined transfer speed is 150 MHz, 75 MHz, or 37.5 MHz, and the second predetermined transfer speed is 150 MHz, 75 MHz, or 37.5 MHz.

11. A device for adjusting transfer speed after initialization of a Serial Advanced Technology Attachment (SATA) interface, the device comprising:
a SATA link device comprising:
a first physical layer device for sending and receiving data at a first transfer speed; and
a first data link layer device for sending a first predetermined primitive through the first physical layer to inquire whether the first transfer speed of the first physical layer device can be adjusted from a first predetermined transfer speed to a second predetermined transfer speed; and
a SATA link partner comprising:
a second physical layer device for sending and receiving data at a second transfer speed; and
a second data link layer device for sending a second predetermined primitive through the second physical layer;
wherein the second data link layer device of the SATA link partner responds to the SATA link device with the second predetermined primitive when the first data link layer device of the SATA link device sends the first predetermined primitive to the second data link layer device of the SATA link partner;
wherein the first physical layer device of the SATA link device adjusts the first transfer speed to the second predetermined transfer speed, and the second physical layer device of the SATA link partner adjusts the second transfer speed to the second predetermined transfer speed when the second predetermined primitive indicates acceptance; and
wherein the first physical layer device of the SATA link device maintains the first transfer speed at the first predetermined transfer speed, and the second physical layer device of the SATA link partner maintains the second transfer speed at the first predetermined transfer speed when the second predetermined primitive indicates rejection.

12. The device of claim 11, wherein:
the SATA link device and the SATA link partner perform an aligning process when the predetermined primitive indicates acceptance;
the first data link layer device of the SATA link device and the second data link layer device of the SATA link partner send a plurality of third predetermined primitives to each other at the second predetermined transfer speed through the first physical layer device and the second physical layer device, respectively.

13. The device of claim 12, wherein the plurality of third predetermined primitives are aligning primitives (ALIGN) of the SATA interface.

14. The device of claim 12, wherein the SATA link device and the SATA link partner both enter a standby mode after the aligning process.

15. The device of claim 12, wherein:
the first data link layer device of the SATA link device receives M third predetermined primitives sent by the SATA link partner in the aligning process;
the second data link layer of the SATA link partner receives N third predetermined primitives sent by the SATA link device during the aligning process;
the aligning process between the SATA link device and the SATA link partner is complete when M and N are both greater than or equal to a threshold number; and
M and N are integers.

16. The device of claim 15, wherein:
the first data link layer device of the SATA link device obtains a first data read level according to the M third predetermined primitives sent by the SATA link partner;
the first data read level is utilized for indicating a first beginning bit when the SATA link partner transmits data; and
the first data link layer device of the SATA link device reads the data sent by the SATA link partner according to the first beginning bit when the SATA link device receives the data sent by the SATA link partner after the aligning process.

17. The device of claim 15, wherein:
the second data link layer device of the SATA link partner obtains a second data read level according to the N third predetermined primitives sent by the SATA link device;
the second data read level is utilized for indicating a second beginning bit when the SATA link device transmits data; and
the second data link layer device of the SATA link partner reads the data sent by the SATA link device according to the second beginning bit when the SATA link partner receives the data sent by the SATA link device after the aligning process.

18. The device of claim 11, wherein the SATA link device and the SATA link partner are both in a standby mode when the first data link layer device of the SATA link device sends the first predetermined primitive.

19. The device of claim 11, wherein the first predetermined primitive is an aligning primitive (ALIGN), a continue primitive (CONT), or a hold primitive (HOLD) of the SATA interface.

20. The device of claim 11, wherein the first predetermined transfer speed is 150 MHz, 75 MHz, or 37.5 MHz, and the second predetermined transfer speed is 150 MHz, 75 MHz, or 37.5 MHz.
